(19) United States
(12) Patent Application Publication
(10) Pub. No.: US 2026/0321468 A1
(43) Pub. Date: Oct. 15, 2026

(54) ALLOY FOR R-T-B BASED PERMANENT MAGNET, METHOD FOR MANUFACTURING ALLOY FOR R-T-B BASED PERMANENT MAGNET, AND METHOD FOR MANUFACTURING R-T-B BASED PERMANENT MAGNET

(71) Applicant: TDK Corporation, Tokyo (JP)

(72) Inventors: Uremu HOSONO, Tokyo (JP); Yasutaka Yoshida, Tokyo (JP)

(73) Assignee: TDK Corporation, Tokyo (JP)

(21) Appl. No.: 19/368,792

(22) Filed: Oct. 24, 2025

(30) Foreign Application Priority Data
Oct. 25, 2024 (JP) 2024-188414
Aug. 12, 2025 (JP) 2025-134496

(51) Int. Cl. H01F 1/057; B22F 1/142; B22F 3/16; B22F 3/24; B22F 9/02; B22F 9/04; C22C 33/04; C22C 38/00; C22C 38/06; C22C 38/10; C22C 38/14; C22C 38/16

(52) U.S. Cl. CPC H01F 1/0577; B22F 1/142; B22F 3/16; B22F 3/24; B22F 9/023; B22F 9/04; C22C 33/04; C22C 38/002; C22C 38/004; C22C 38/005; C22C 38/06; C22C 38/10; C22C 38/14; C22C 38/16; B22F 2003/248; B22F 2009/044; B22F 2202/05; B22F 2998/10; B22F 2999/00; C22C 2202/02

(57) ABSTRACT

An alloy for an R-T-B based permanent magnet contains at least one rare earth element, at least one selected from the group consisting of Fe and Co, boron, and M. M represents at least one selected from the group consisting of Ga, Al, Cu, Zn, In, P, Sb, Si, Ge, Sn, and Bi. The alloy for an R-T-B based permanent magnet contains a main phase and an R-rich phase. In a cross section of the alloy, an area ratio of a 6-13-1 phase, as one type of the R-rich phase, is 7.0% or less.

### BACKGROUND

The present disclosure relates to an alloy for an R-T-B based permanent magnet, a method for manufacturing an alloy for an R-T-B based permanent magnet, and a method for manufacturing an R-T-B based permanent magnet.

Patent Document 1 describes an invention related to a raw material alloy for an R-T-B based magnet. In particular, the raw material alloy for an R-T-B based magnet has a microstructure in which an amorphous phase and a crystal phase coexist in an R-rich phase. The amorphous phase has a Ga content ratio higher than that of the crystal phase. This feature improves the saturation magnetization of the main phase of the finally obtained sintered magnet and also improves the energy product of the sintered magnet, as well as enhances and stabilizes the coercivity.
Patent Document 1: JP 5758016 (B2)

### SUMMARY

An alloy for an R-T-B based permanent magnet according to the present disclosure contains at least one rare earth element, at least one selected from the group consisting of Fe and Co, boron, and M, wherein
M is at least one selected from the group consisting of Ga, Al, Cu, Zn, In, P, Sb, Si, Ge, Sn, and Bi,
the alloy contains a main phase and an R-rich phase, and
an area ratio of a 6-13-1 phase, which is a type of the R-rich phase, is 7.0% or less in a cross section of the alloy.

A method for manufacturing an alloy for an R-T-B based permanent magnet according to the present disclosure includes:
a step of solidifying a molten alloy to obtain a cast alloy strip;
a step of crushing the cast alloy strip to obtain cast alloy pieces; and
a step of cooling the cast alloy pieces, wherein,
in the step of cooling the cast alloy pieces, a cooling rate in a range from 600 to 400° C. is 0.7° C./s or more.

### BRIEF DESCRIPTION OF THE DRAWINGS

FIG. 1 is a backscattered electron image of coarsely pulverized powder of an alloy for an R-T-B based permanent magnet;

FIG. 2 is a backscattered electron image of coarsely pulverized powder of the alloy for an R-T-B based permanent magnet;

FIG. 3 is a backscattered electron image of coarsely pulverized powder of the alloy for an R-T-B based permanent magnet;

FIG. 4 is a backscattered electron image of coarsely pulverized powder of the alloy for an R-T-B based permanent magnet;

FIG. 5 is a backscattered electron image of the alloy for an R-T-B based permanent magnet;

FIG. 6 is a ternary image obtained from the image in FIG. 5; and

FIG. 7 is a schematic diagram showing a method of measuring a distance between R-rich phases of the alloy for an R-T-B based permanent magnet.

### DETAILED DESCRIPTION OF THE PREFERRED EMBODIMENTS

An object of the present disclosure is to provide an alloy for an R-T-B based permanent magnet from which an R-T-B based permanent magnet having high magnetic properties can be manufactured with reduced likelihood of cracking.

The area ratio of the 6-13-1 phase may be 1.0% or more and 6.5% or less.

An area ratio of a 2-17 phase may be 2.0% or less in a cross section of the alloy for the R-T-B based permanent magnet.

The content of boron may be 0.78 mass % or more and 0.95 mass % or less.

The content of boron may be 0.80 mass % or more and 0.95 mass % or less.

The content of boron may be 0.83 mass % or more and 0.90 mass % or less.

The content of boron may be 0.75 mass % or more and 0.95 mass % or less, and the content of carbon may be 0.05 mass % or more and 0.25 mass % or less.

The total of the content of boron and the content of carbon may be 0.80 mass % or more and 1.20 mass % or less, and a value that is obtained by dividing the content of carbon by the content of boron may be 0.05 or more and 0.33 or less.

The content of Ga may be 0.10 mass % or more and 0.70 mass % or less.

The total content of rare earth elements may be 30.0 mass % or more and 33.0 mass % or less.

The total content of rare earth elements may be 30.0 mass % or more and 33.0 mass % or less, the content of Al may be 0.1 mass % or more and 0.4 mass % or less, the content of Co may be 0.4 mass % or more and 1.1 mass % or less, the content of Cu may be 0.05 mass % or more and 0.2 mass % or less, the content of Zr may be 0.15 mass % or more and 0.7 mass % or less, and the content of Ga may be 0.10 mass % or more and 0.70 mass % or less.

A method for manufacturing an R-T-B based permanent magnet according to the present disclosure includes a step of performing hydrogenation pulverization on the above-described alloy for the R-T-B based permanent magnet, wherein, in the step of performing hydrogenation pulverization, a dehydrogenation temperature is 530° C. or more and 650° C. or less.

Hereinafter, the present disclosure will be described with reference to the embodiments shown in the drawings.

### <Structure of Alloy for R-T-B Based Permanent Magnet>

An alloy for an R-T-B based permanent magnet according to the present embodiment contains at least one rare earth element, at least one selected from the group consisting of Fe and Co, boron, and M. M represents at least one selected from the group consisting of Ga, Al, Cu, Zn, In, P, Sb, Si, Ge, Sn, and Bi.

In general, an alloy for an R-T-B based permanent magnet includes a main phase having an R₂T₁₄B type crystal structure and an R-rich phase having an R content larger than that of the main phase.

Typically, in observing a backscattered electron image of a cross section of an alloy for an R-T-B based permanent magnet, a region with a larger average atomic number appears brighter (whiter). The R-rich phase has an average atomic number larger than that of the main phase.

By appropriately adjusting the luminance histogram of a backscattered electron image, R-rich phases can be separated into multiple types according to their luminance in the backscattered electron image.

Specifically, the R-rich phases can be separated into the brightest white phase and a 6-13-1 phase (intermediate phase), which has a luminance between that of the white phase and that of the main phase. In the alloy for an R-T-B based permanent magnet according to the present embodiment, the area ratio of the 6-13-1 phase in a cross section is 7.0% or less (including 0%). This area ratio may be 1.0% or more and 6.5% or less, or 1.0% or more and 6.0% or less.

That is, the alloy for an R-T-B based permanent magnet according to the present embodiment has a small area ratio of the 6-13-1 phase compared with that of an existing alloy for an R-T-B based permanent magnet. Using the alloy for an R-T-B based permanent magnet having a small area ratio of the 6-13-1 phase facilitates improvement in magnetic properties of the resultant R-T-B permanent magnet. The following describes the reasons for the facilitated improvement in magnetic properties of an R-T-B based permanent magnet.

In the main phase, a value obtained by dividing the total ratio of Fe and Co by the total ratio of rare earth elements, in terms of number of atoms, may be 6.0 or more and 7.0 or less. On the other hand, in the 6-13-1 phase, a value in which the total ratio of Fe and Co is divided by the total ratio of rare earth elements, in terms of number of atoms, may be more than 1.0 and 3.0 or less. In the white phase, a value in which the total ratio of Fe and Co is divided by the total ratio of rare earth elements, in terms of number of atoms, may be 0 or more and 1.0 or less. The 6-13-1 phase contains Fe and Co in relatively large amounts among the R-rich phases. In contrast, the white phase contains Fe and Co in relatively small amounts among the R-rich phases. The type of the 6-13-1 phase is not particularly limited, and it may be an R₆T₁₃M compound having a La₆Co₁₁Ga₃ type crystal structure, for example.

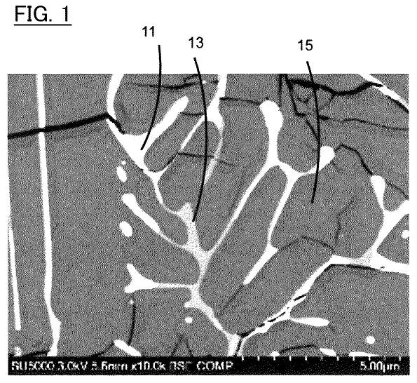

FIGS. 1 to 4 show backscattered electron images of cross sections of coarsely pulverized powders obtained by hydrogenation pulverization treatment under different dehydrogenation temperatures, for the same alloy for an R-T-B based permanent magnet. Specifically, the coarsely pulverized powders after hydrogenation pulverization treatment were embedded in resin, and the rein-embedded samples were polished to prepare cross sections, which were then observed.

FIGS. 1 to 4 show results obtained by hydrogenation pulverization treatment at dehydrogenation temperatures of 400° C., 500° C., 600° C., and 640° C., respectively. The observations were made at a magnification of 10,000.

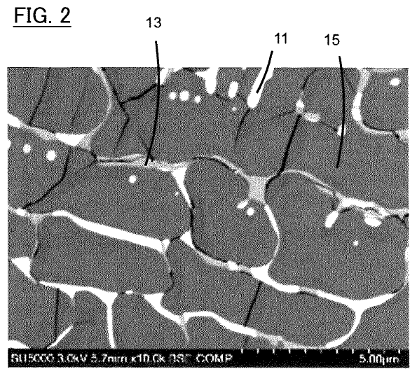

In FIGS. 1 and 2, which show results at relatively low dehydrogenation temperatures, white phase 11, 6-13-1 phase 13, and main phase 15 were clearly observed.

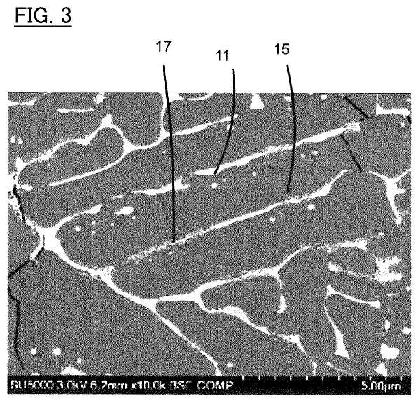

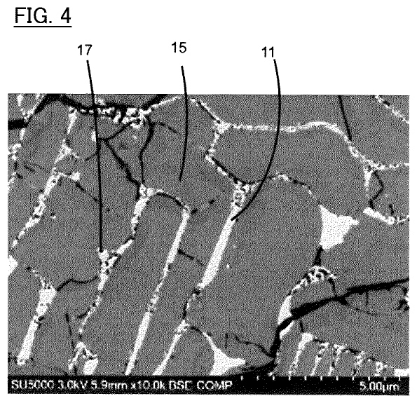

On the other hand, in FIGS. 3 and 4, which show results at relatively high dehydrogenation temperatures, the area of the 6-13-1 phase 13 was significantly decreased, and instead, black dot-like phase 17 was formed. The vicinity of the black dot-like phase 17 tends to appear whiter than the vicinity of the 6-13-1 phase 13. The black dot-like phase 17 is presumed to mainly contain fine particles of at least one selected from the group consisting of Fe and Co. That is, in the black dot-like phase 17, the value obtained by dividing the total ratio of Fe and Co by the total ratio of rare earth elements is significantly high. It is supposed that, at high dehydrogenation temperatures, the 6-13-1 phase 13 decomposes to form the dot-like phase 17.

In the case of manufacturing an R-T-B based permanent magnet using such an alloy powder containing a large number of fine particles of at least one selected from the group consisting of Fe and Co, the resulting permanent magnet tends to exhibit reduced magnetic properties, particularly in the squareness ratio Hk/HcJ.

The fine particles of at least one selected from the group consisting of Fe and Co are less likely to be generated in the alloy powder when the dehydrogenation temperature is lowered. However, when the dehydrogenation temperature is lowered, the amount of hydrogen remaining in the alloy powder increases. This causes cracks to occur easily in the pressing step and/or the sintering step due to release of hydrogen.

In view of this, the area ratio of the 6-13-1 phase 13 in a cross section of the alloy for an R-T-B based permanent magnet is reduced, specifically to 7.0% or less. This reduces the amount of formation of the dot-like phase 17 even when dehydrogenation is conducted at a relatively high temperature. That is, in the case where dehydrogenation is performed at a temperature sufficiently high to suppress occurrence of cracks, the magnetic properties of the resulting R-T-B based permanent magnet can be more readily maintained by reducing the area ratio of the 6-13-1 phase 13.

The area ratio of the 6-13-1 phase 13 may be 1.0% or more and 6.5% or less. When the area ratio of the 6-13-1 phase 13 is less than 1.0%, the average distance between R-rich phases (to be described later) is less likely to be 2.0 μm or more and 4.0 μm or less. When the area ratio of the 6-13-1 phase 13 is 1.0% or more and 6.5% or less, in particular, Hk/HcJ tends to be improved compared with the case where the area ratio of the 6-13-1 phase 13 exceeds 6.5%.

In the present embodiment, there is no particular limitation on the average distance between R-rich phases in a cross section of the alloy for an R-T-B based permanent magnet; however, magnetic properties tend to be improved when the average distance is 2.0 μm or more and 4.0 μm or less.

The area ratio of a 2-17 phase (R₂T₁₇ phase) is preferably small in a cross section of the alloy for an R-T-B based permanent magnet according to the present embodiment. More preferably, the 2-17 phase is not observed in a backscattered electron image of a cross section of the alloy for an R-T-B based permanent magnet. As the area ratio of the 2-17 phase increases, magnetic properties tend to decrease. While the upper limit of the area ratio of the 2-17 phase is not particularly limited, the area ratio of the 2-17 phase is preferably 2.0% or less.

It is preferable that the area ratio of the dot-like phase 17 is small in a cross section of the alloy for an R-T-B based permanent magnet according to the present embodiment. More preferably, the dot-like phase 17 is not observed in a backscattered electron image of a cross section of the alloy for an R-T-B based permanent magnet.

### <Method of Calculating Area Ratio of Each Phase>

In the present embodiment, the area ratio of each phase in a cross section of the alloy for an R-T-B based permanent magnet is calculated using a backscattered electron image, which can be obtained by SEM or the like. The area ratio of each phase in a cross section of the alloy for an R-T-B based permanent magnet may be regarded as the volume ratio of the corresponding phase in this alloy.

First, luminance and contrast of a backscattered electron image are adjusted. Specifically, an obtained backscattered electron image is used to generate a luminance histogram. The luminance and contrast of the backscattered electron image are then adjusted so that the luminances of the main phase and the white phase are about 70 and about 240, respectively, assuming that the luminances of the darkest part and the brightest part are 0 and 255, respectively. By thus adjusting the image quality of the backscattered electron image, the luminance of the 6-13-1 phase is about 140. Then, the backscattered electron image is subjected to ternarization using a known k-means clustering, and the phases in the image are classified into three types: the main phase, the 6-13-1 phase, and the white phase. For adjustment of luminance of a backscattered electron image, the entire backscattered electron image is set to correspond to the cross section of the alloy for an R-T-B based permanent magnet.

Next, the numbers of pixels of the white phase and the 6-13-1 phase are counted by image analysis in the ternarized backscattered electron image. Then, the ratio of the number of pixels of each phase to the total number of pixels of the backscattered electron image is calculated, thereby obtaining the area ratio of each phase. The area ratio of the main phase may be obtained by analyzing the number of pixels of the main phase, or alternatively, may be calculated according to the following formula: 1−(area ratio of the white phase+area ratio of the 6-13-1 phase).

The presence or absence and area ratio of the 2-17 phase can be determined using a backscattered electron image. As necessary, EDS may be used in combination. The presence or absence and area ratio of the dot-like phase can be determined using a backscattered electron image.

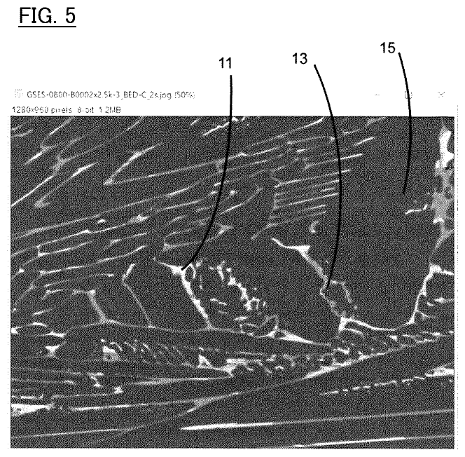

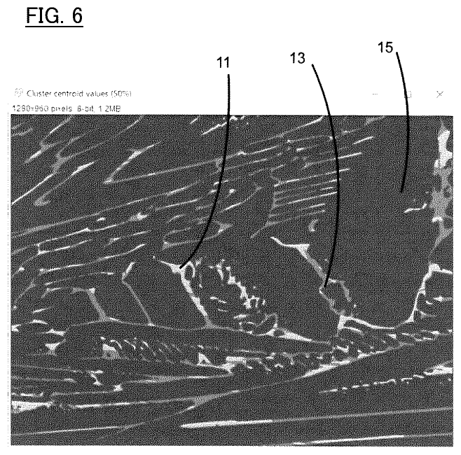

FIG. 5 is an example of a backscattered electron image of a cross section of the alloy for an R-T-B based permanent magnet according to the present embodiment. FIG. 6 is a backscattered electron image obtained from FIG. 5 after ternarization using a k-means clustering.

### <Method of Measuring Average Distance Between R-Rich Phases>

A method of measuring an average distance between R-rich phases will be described. First, an obtained backscattered electron image is adjusted in luminance so that the main phase appears gray, and the 6-13-1 phase and the white phase appear white. In short, the luminance is adjusted so that the main phase appears gray and the R-rich phase appears white.

Next, measurement lines perpendicular to the thickness direction of the alloy for an R-T-B based permanent magnet are set at equal intervals in the backscattered electron image (for example, at equal intervals of 5 to 50 μm). The measurement lines are made to have the same length.

The following describes a method of calculating the average distance between R-rich phases for a single measurement line. First, the number of R-rich phases in contact with the measurement line is counted. Then, the length of the measurement line is divided by the number of the R-rich phases in contact with it to obtain the average distance between R-rich phases along the measurement line.

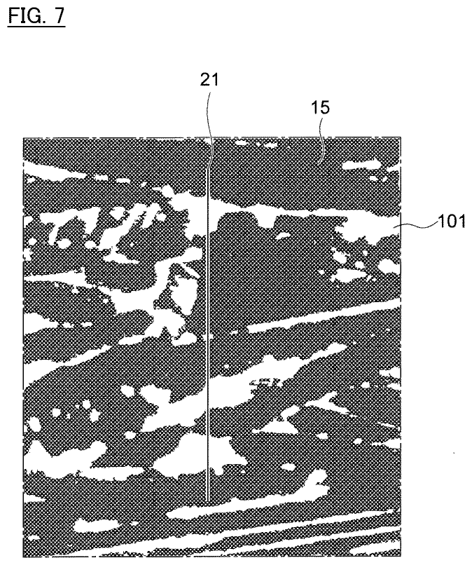

A schematic diagram illustrating a relationship between a measurement line and each phase is shown in FIG. 7. In FIG. 7, the average distance between R-rich phases along a measurement line 21 is a value obtained by dividing the length of the measurement line 21 by the number of R-rich phases 101 in contact therewith. The number of R-rich phases 101 in contact with the measurement line 21 is 4. Thus, the value obtained by dividing the length of the measurement line 21 by 4 represents the average distance between R-rich phases along the measurement line 21.

Then, the sum of the average distances between R-rich phases along all measurement lines is divided by the number of measurement lines. Thus, the average distance between R-rich phases in the alloy for an R-T-B based permanent magnet is obtained.

The number of measurement lines is not particularly limited, and is preferably at least 10. The length of a measurement line is not particularly limited, and is preferably at least 100 μm. In addition, the length of the measurement lines is set so that each measurement line contacts at least one R-rich phase.

### <Composition of Alloy for R-T-B Based Permanent Magnet>

The composition of the alloy for an R-T-B based permanent magnet is not particularly limited, except that it contains at least one rare earth element (R), at least one selected from the group consisting of Fe and Co, boron, and M, as described above. The rare earth elements are Sc, Y, and lanthanoids that belong to the third group of the long-form periodic table. Examples of lanthanoids include La, Ce, Pr, Nd, Sm, Eu, Gd, Tb, Dy, Ho, Er, Tm, Yb, and Lu. The rare earth elements are classified into light rare earth elements and heavy rare earth elements. The heavy rare earth elements refer to Gd, Tb, Dy, Ho, Er, Tm, Yb, and Lu. The light rare earth elements refer to rare earth elements other than the heavy rare earth elements. In the present embodiment, in view of suitably controlling manufacturing cost and magnetic properties, R may include at least one selected from the group consisting of Nd and Pr. In addition, both a light rare earth element and a heavy rare earth element may be contained, particularly in view of improving HcJ. The content of the heavy rare earth elements is not particularly limited, and the heavy rare earth element may be absent. The content of the heavy rare earth elements is, for example, 5 mass % or less (including 0 mass %). M is at least one selected from the group consisting of Ga, Al, Cu, Zn, In, P, Sb, Si, Ge, Sn, and Bi.

The R content may be 30.0 mass % or more and 33.0 mass % or less, or may be 30.0 mass % or more and 31.5 mass % or less.

The B content may be 0.78 mass % or more and 1.00 mass % or less, or may be 0.80 mass % or more and 1.00 mass % or less. The B content may be 0.78 mass % or more and 0.95 mass % or less, or may be 0.80 mass % or more and 0.95 mass % or less. The B content may be 0.83 mass % or more and 0.90 mass % or less, or may be 0.86 mass % or more and 0.90 mass % or less. As the B content decreases, the area ratio of the 6-13-1 phase tends to increase. As the B content increases, the area ratio of the 6-13-1 phase tends to decrease. In addition, an excessively low B content can cause the 2-17 phase to precipitate readily.

The C content may be 0.000 mass % or more and 0.25 mass % or less, or may be 0.002 mass % or more and 0.20 mass % or less. When the C content falls within such a range, magnetic properties tend to be improved.

The C content may be 0.05 mass % or more and 0.25 mass % or less, and the B content may be 0.75 mass % or more and 1.00 mass % or less. The C content may be 0.05 mass % or more and 0.25 mass % or less, and the B content may be 0.78 mass % or more and 0.95 mass % or less.

While the B content and the C content fall within the above-described ranges, the total of the B content and the C content may be 0.80 mass % or more and 1.20 mass % or less, or may be 0.80 mass % or more and 1.10 mass % or less. Optionally, the ratio of the C content to the B content may be 0.05 or more and 0.33 or less, or may be 0.06 or more and 0.30 or less. When the B content, the C content, the total of the B content and the C content, and the ratio of the C content to the B content are all within the above-described ranges, the area ratio of the 6-13-1 phase is small, tending to improve magnetic properties.

When the B content is relatively small, that is, when the B content is 0.75 mass % or more and 0.80 mass % or less, or 0.75 mass % or more and 0.77 mass % or less, it is difficult to reduce the area ratio of the 6-13-1 phase. Even in such cases, the area ratio of the 6-13-1 phase can be readily reduced by setting the C content at 0.05 mass % or more and 0.25 mass % or less.

The Co content may be 0.4 mass % or more and 3.0 mass % or less, or may be 0.4 mass % or more and 2.0 mass % or less, or alternatively, may be 0.4 mass % or more and 1.1 mass % or less. As the Co content decreases, corrosion resistance tends to decrease as well. When the Co content is large, coercivity and squareness ratio tend to decrease. In addition, as the Co content increases, the alloy for an R-T-B based permanent magnet is likely to become expensive.

The total content of M is not particularly limited. The total content of M may be 0.4 mass % or more and 2.0 mass % or less. M may substantially consist of at least one selected from the group consisting of Ga, Al, and Cu. That is, M may contain at least one element other than Ga, Al, and Cu, each in an amount of 0.1 mass % or less.

The Cu content is not particularly limited. For example, the Cu content may be 0.0 mass % or more and 0.5 mass % or less, or may be 0.05 mass % or more and 0.3 mass % or less, or alternatively, may be 0.05 mass % or more and 0.2 mass % or less. When the Cu content falls within the predetermined range, magnetic properties tend to improve.

The Ga content is not particularly limited. For example, the Cu content may be 0.1 mass % or more and 1.5 mass % or less, or may be 0.1 mass % or more and 1.0 mass % or less, or alternatively, may be 0.1 mass % or more and 0.7 mass % or less. When the Ga content falls within the predetermined range, magnetic properties tend to improve. In addition, as the Ga content decreases, the 6-13-1 phase is less likely to precipitate.

The Al content is not particularly limited. For example, the Al content may be 0.1 mass % or more and 0.5 mass % or less, or may be 0.1 mass % or more and 0.4 mass % or less. When the Al content falls within the predetermined range, magnetic properties tend to improve.

The alloy for an R-T-B based permanent magnet according to the present embodiment may contain Zr, in addition to Fe, Co, B, M, and at least one rare earth element. The Zr content is not particularly limited. For example, the Zr content may be 0.0 mass % or more and 0.7 mass % or less, or may be 0.15 mass % or more and 0.7 mass % or less, or alternatively, may be 0.3 mass % or more and 0.5 mass % or less. When the Zr content is excessive, magnetic properties, in particular Br and Hk/HcJ, tend to decrease.

The Fe content is substantially the balance of the constituents of the alloy for an R-T-B based permanent magnet. The condition that the Fe content is substantially the balance refers to a case where the total content of elements other than R, Fe, Co, B, M, and Zr is 0.2 mass % or less.

An R-T-B based permanent magnet that is manufactured using the alloy for the R-T-B based permanent magnet according to the present embodiment may be processed into any desired shape for use. The shape of the R-T-B based permanent magnet is not particularly limited and may be any shape. Examples of the shape include any shapes such as a rectangular parallelepiped, a hexahedron, a plate-like shape, and columnar shapes such as a quadrangular prism shape, as well as cylindrical shapes having a C-shaped cross section.

The R-T-B based permanent magnet includes both a magnetized magnet and an unmagnetized magnet.

### <Method for Manufacturing Alloy for R-T-B Based Permanent Magnet>

As an example of a method for manufacturing an alloy for an R-T-B based permanent magnet, a manufacturing method using strip casting will be described.

A casting apparatus may include components known as those of a typical casting apparatus, such as a refractory crucible, a tundish, a cooling roll, and a collection container. The type of the refractory crucible is not particularly limited. Examples thereof include an alumina crucible, a mullite crucible, and a zirconia crucible. The material of the cooling roll is not particularly limited. For example, copper, a copper alloy, copper having a plated or thermal sprayed surface, and a copper alloy having a plated or thermal sprayed surface may be used.

First, raw material metals are weighed in proportions corresponding to the alloy composition of a target alloy for an R-T-B based permanent magnet, and they are mixed to obtain a raw material mixture.

Next, the obtained raw material mixture is loaded into the refractory crucible, and the loaded raw material mixture is melted into a molten alloy. The method for melting the raw material mixture is not particularly limited. For example, a refractory crucible that is loaded with a raw material mixture may be placed in a high-frequency vacuum induction furnace and may be heated.

Then, the obtained molten alloy is cast to form a cast alloy strip (the alloy for an R-T-B based permanent magnet). In more detail, a molten alloy is supplied via the tundish onto the cooling roll having a water-cooled interior. The molten alloy that is supplied onto the cooling roll is cooled and is separated from the cooling roll on the side opposite to the tundish, to form a cast alloy strip.

The cast alloy strip is crushed into flake-like cast alloy pieces by a crusher that is disposed between the cooling roll and the collection container. The flake-like cast alloy pieces accumulate in the collection container to form an accumulation.

The cast alloy strip has a roll surface, which is a surface that contacts the cooling roll, and a free surface, which is a surface opposite to the roll surface. The roll surface and the free surface can be distinguished even in a flake-like alloy for an R-T-B based permanent magnet.

The temperature of the molten alloy is not particularly limited. For example, the temperature of the molten alloy is 1300 to 1600° C. The roll peripheral speed of the cooling roll is not particularly limited. For example, the roll peripheral speed is 0.5 to 2.5 m/s. Also, the supply rate of the molten alloy to the cooling roll is not particularly limited. For example, the supply rate is 0.5 to 2.5 kg/(min cm).

The cast alloy strip is crushed to obtain flake-like cast alloy pieces. The flake-like cast alloy pieces are then cooled in the collection container.

In general, cooling of the cast alloy using the cooling roll may be referred to as primary cooling, and cooling of the cast alloy in the collection container may be referred to as secondary cooling. In the present embodiment, the area ratio of the 6-13-1 phase can be reduced by adjusting the cooling rate during the secondary cooling.

It is possible to reduce the area ratio of the 6-13-1 phase by increasing the cooling rate, particularly in the range from 600 to 400° C. during the secondary cooling. Specifically, an average cooling rate in the range from 600 to 400° C. is set at 0.7° C./s or more. There is no particular upper limit for the average cooling rate in the range from 600 to 400° C., but it may be 10° C./s or less, for example. As the average cooling rate in the range from 600 to 400° C. increases, the distance between R-rich phases tends not to increase.

If the cast alloy is already 600° C. or below upon entering the collection container, “600° C.” mentioned above is read as “temperature at the time of the cast alloy entering the collection container (which may hereinafter be referred to as the maximum temperature)”.

In widely used existing methods, the cooling rate during the primary cooling is mainly controlled, thereby controlling the cooling rate in a relatively high temperature range from the melting point to 600° C. On the other hand, in the present embodiment, the cooling rate during the secondary cooling is controlled to be high particularly in the range of 600° C. or less, thereby reducing the area ratio of the 6-13-1 phase. With the area ratio of the 6-13-1 phase reduced, generation of the dot-like phase is suppressed even when the dehydrogenation temperature is high during hydrogenation pulverization. Thus, the finally obtained magnet can have improved magnetic properties.

To achieve a high cooling rate in the range of 600° C. or less, a crusher is disposed between the cooling roll and the collection container. The cast alloy strip is crushed first after the primary cooling, thereby obtaining flake-like cast alloy pieces. Then, the cast alloy pieces are cooled in the collection container, which is provided with a cooling member. The type of the cooling member is not particularly limited, and examples include cooling plates such as a Cu plate or an Fe plate. Optionally, inert gas may be supplied into the collection container as cooling gas.

The cooling rate during the secondary cooling is increased by enhancing the cooling capacity. This may increase the production cost. However, the present embodiment adopts the approach of enhancing the cooling capacity to achieve a high cooling rate in the secondary cooling.

### <Method for Manufacturing R-T-B Based Permanent Magnet>

There is no particular limitation on the method for manufacturing an R-T-B based permanent magnet using the flake-like alloy produced by the above-described method. For example, a method having the following steps can be employed:
(a) a pulverization step of pulverizing the alloy for an R-T-B based permanent magnet;
(b) a pressing step of pressing the obtained alloy powder;
(c) a sintering step of sintering the green compact to obtain the R-T-B based permanent magnet;
(d) an aging treatment step of subjecting the R-T-B based permanent magnet to an aging treatment;
(e) a cooling step of cooling the R-T-B based permanent magnet;
(f) a machining step of machining the R-T-B based permanent magnet;
(g) a grain boundary diffusion step of diffusing at least one heavy rare earth element into grain boundaries of the R-T-B based permanent magnet; and
(h) a surface treatment step of subjecting the R-T-B based permanent magnet to a surface treatment.

### [Pulverization Step]

The flake-like alloy for an R-T-B based permanent magnet is pulverized (pulverization step). The pulverization step includes a coarse pulverization step of pulverizing the alloy to a particle size of about several hundred μm to several mm, and a fine pulverization step of finely pulverizing the alloy to a particle size of about several μm.

### (Coarse Pulverization Step)

The alloy for an R-T-B based permanent magnet is coarsely pulverized until the particle size is about several hundred μm to several mm (coarse pulverization step). This step provides a coarsely pulverized powder of the alloy for an R-T-B based permanent magnet. The coarse pulverization can be carried out as follows: for example, after hydrogen is absorbed in the alloy for an R-T-B based permanent magnet, dehydrogenation is performed by allowing hydrogen to be released due to differences in hydrogen storage capacity among phases, thereby causing pulverization by self-collapsing. Such pulverization is referred to as hydrogenation pulverization.

The oxygen concentration in each manufacturing step is adjusted by controlling the atmosphere or the like. From the viewpoint of obtaining high magnetic properties, the oxygen content in the finally obtained R-T-B based permanent magnet may be reduced. For this purpose, the oxygen concentration in each step from the pulverization step to the sintering step (to be described later) may be 100 ppm or less.

In pulverizing the alloy for an R-T-B based permanent magnet having a small area ratio of the 6-13-1 phase according to the present embodiment, magnetic properties, particularly the squareness ratio, can be suitably maintained even if the dehydrogenation temperature is set relatively high. The dehydrogenation temperature is preferably 530° C. or more and 650° C. or less. When the dehydrogenation temperature is excessively low, cracks are likely to occur in an R-T-B based permanent magnet after pressing and/or sintering. When the dehydrogenation temperature is excessively high, the dot-like phase 17 tends to occur in the coarsely pulverized powder of a dehydrogenated alloy for an R-T-B based permanent magnet.

### (Fine Pulverization Step)

After coarsely pulverizing the alloy for an R-T-B based permanent magnet, the obtained coarsely pulverized powder is finely pulverized until an average particle size is several μm or so (fine pulverization step). Thus, a finely pulverized powder of the alloy for an R-T-B based permanent magnet is obtained. By further finely pulverizing the coarsely pulverized powder, for example, the finely pulverized powder having particles of 1 μm or more and 10 μm or less, or 3 μm or more and 5 μm or less, can be obtained.

The fine pulverization is carried out by further pulverizing the coarsely pulverized powder using a fine pulverizer, such as a jet mill, a ball mill, a vibrating mill, and a wet attritor while conditions such as pulverization time are appropriately regulated. Jet milling is a method of fine pulverization in which a high-pressure inert gas (for example, N₂ gas) is released from a narrow nozzle to generate a high-speed gas flow. The high-speed gas flow accelerates the coarsely pulverized powder of the raw material alloy, causing the coarsely pulverized powder particles to collide with each other or with a target or a container.

When the coarsely pulverized powder of the raw material alloy is finely pulverized, a pulverization aid such as zinc stearate, urea, stearamide, or oleamide may be added to obtain finely pulverized powder that exhibits high orientation during pressing.

### [Pressing Step]

The finely pulverized powder is pressed into a desired shape (pressing step). In the pressing step, the finely pulverized powder is charged into a mold disposed between electromagnets, and pressure is applied to form the powder into a desired shape. At this time, a magnetic field is applied to cause the finely pulverized powder to be oriented in a predetermined direction. That is, pressing is performed in the magnetic field with the crystal axes oriented. This yields a green compact. The obtained green compact is oriented in a specific direction, whereby an R-T-B based permanent magnet having enhanced magnetic anisotropy can be obtained.

The pressure during pressing may be 30 to 300 MPa. The applied magnetic field may be 950 to 1600 kA/m. The applied magnetic field is not limited to a static magnetic field, and a pulsed magnetic field may also be used. The static magnetic field and the pulsed magnetic field can be used together.

The pressing may be dry pressing, in which the finely pulverized powder is pressed as it is, as described above. Alternatively, the pressing may be wet pressing, in which a slurry containing the finely pulverized powder dispersed in a solvent, such as oil, is pressed.

The shape of the green compact, which is obtained by pressing the finely pulverized powder, is not particularly limited. The shape may be appropriately selected depending on the desired shape of an R-T-B based permanent magnet and may be a rectangular parallelepiped, a plate shape, a columnar shape, or a ring shape, for example.

### [Sintering Step]

The green compact, which is obtained by pressing the powder into a desired shape in a magnetic field, is sintered in a vacuum or in an inert gas atmosphere, thereby obtaining an R-T-B based permanent magnet (sintering step). The sintering temperature is adjusted depending on various conditions such as composition, pulverization method, particle size, and particle size distribution. For example, the green compact is sintered by heating it at a temperature of 1000° C. or more and 1200° C. or less for 1 to 48 hours in a vacuum or in an inert gas atmosphere. Thus, the finely pulverized powder is subjected to liquid phase sintering, thereby producing an R-T-B based permanent magnet (a sintered body of an R-T-B based magnet) having an increased volume fraction of the main phase. After sintering the green compact to obtain a sintered body, the sintered body may be quenched from the viewpoint of improving production efficiency.

In particular, when the alloy for an R-T-B based permanent magnet contains a small amount of boron, a magnet having favorable properties tends to be obtained by sintering at a relatively low temperature for a relatively long time. In addition, even when the alloy for an R-T-B based permanent magnet contains a small amount of boron, a magnet having favorable properties can be readily obtained by sufficiently increasing the content of carbon.

### [Aging Treatment Step]

After sintering the green compact, an aging treatment is performed on the R-T-B based permanent magnet (aging treatment step). After sintering, the obtained R-T-B based permanent magnet is subjected to an aging treatment, for example, by holding it at a temperature lower than the sintering temperature, or by other methods. In the aging treatment, the treatment conditions are appropriately adjusted depending on the number of aging steps. For example, two-step heating may be performed by heating at a temperature of 700° C. or more and 1000° C. or less for 10 minutes to 6 hours and further heating at a temperature of 500 to 700° C. for 10 minutes to 6 hours. In another embodiment, one-step heating may be performed by heating at a temperature of around 600° C. for 10 minutes to 6 hours. Such an aging treatment can improve the magnetic properties of the R-T-B based permanent magnet. The aging treatment step may be carried out after the machining step which is described below.

### [Cooling Step]

After the R-T-B based permanent magnet is subjected to the aging treatment, it is quenched in an Ar gas atmosphere (cooling step). Thus, the R-T-B based permanent magnet according to the present embodiment is finally obtained. The cooling rate is not particularly limited and may be 30° C./m or more.

### [Machining Step]

The obtained R-T-B based permanent magnet may be machined into a desired shape as necessary (machining step). Examples of machining methods include shaping processes such as cutting and grinding, and chamfering processes such as barrel polishing.

### [Grain Boundary Diffusion Step]

At least one heavy rare earth element may be further diffused to grain boundaries of the machined R-T-B based permanent magnet (grain boundary diffusion step). The method of grain boundary diffusion is not particularly limited. The grain boundary diffusion may be performed as follows: for example, a compound containing at least one heavy rare earth element is applied to the surface of the R-T-B based permanent magnet by coating, deposition, or another method, and a heat treatment is then performed on the magnet. In another embodiment, the grain boundary diffusion may be performed by subjecting the R-T-B based permanent magnet to a heat treatment in an atmosphere containing a vapor of at least one heavy rare earth element. The grain boundary diffusion can further improve HcJ of the R-T-B based permanent magnet.

### [Surface Treatment Step]

The R-T-B based permanent magnet that is obtained by the above-described steps may be further subjected to a surface treatment such as plating, resin coating, oxidation treatment, or chemical conversion treatment (surface treatment step).

Although the machining step, the grain boundary diffusion step, and the surface treatment step are performed in the present embodiment, one or more of these steps may be omitted as appropriate.

The above describes an example of a single alloy method in which a magnet is manufactured from one type of alloy having a composition close to that of the finally obtained magnet. The method for manufacturing a magnet according to the present embodiment is not limited to the single alloy method. Another example is the use of a dual alloy method in which a magnet is manufactured from two types of alloys: a main-phase alloy mainly forming the main phase, and a boundary-phase alloy mainly forming the grain boundary phase. At least the main-phase alloy can be the alloy for R-T-B based permanent magnet according to the present embodiment. The boundary-phase alloy may also be used together with the main-phase alloy as the alloy for an R-T-B based permanent magnet according to the present embodiment.

In using the dual alloy method, the compositions of the main-phase alloy and the boundary-phase alloy, and the mixing ratio between them, are determined in accordance with the composition of the intended R-T-B based permanent magnet. Except for the above, the same conditions as in the single alloy method can be applied to the dual alloy method.

The main-phase alloy and the boundary-phase alloy may be mixed so that the ratio of the main-phase alloy in the total amount of the main-phase alloy and the boundary-phase alloy is 85 mass % or more. In this case, the finally obtained R-T-B based permanent magnet predominantly exhibits the characteristics of the main-phase alloy. That is, the properties of the finally obtained R-T-B based permanent magnet can be suitably controlled by adjusting the area ratio of the 6-13-1 phase in a cross section of the main-phase alloy.

In particular, the main-phase alloy and the boundary-phase alloy may be mixed at a mixing ratio of 85:15 to 95:5 (the main-phase alloy: the boundary-phase alloy, in terms of mass), with the area ratio of the 6-13-1 phase in a cross section of the main-phase alloy being 7.0% or less. Under these conditions, the finally obtained R-T-B based permanent magnet is less likely to have cracks and has improved magnetic properties.

The main-phase alloy can be manufactured by a method similar to that used for manufacturing the alloy for an R-T-B based permanent magnet by the single alloy method.

The area ratio of the 6-13-1 phase in the boundary-phase alloy is not particularly limited. The area ratio of the 6-13-1 phase in the boundary-phase alloy may be 50% or less, or 30% or less. The area ratio of the a-Fe phase in the boundary-phase alloy may be 10% or less, or 5% or less.

The method for manufacturing the boundary-phase alloy is not particularly limited. This method may be the same as that for manufacturing the alloy for an R-T-B based permanent magnet by the single alloy method. In particular, an average cooling rate in the range from 600 to 400° C. may be set at 0.7° C./s or more. In this case, a boundary-phase alloy containing the 6-13-1 phase and the a-Fe phase with area ratios in the above-described ranges is easily obtained.

The thus obtained R-T-B based permanent magnet according to the present embodiment has good magnetic properties and can be obtained by sintering within a wide sintering temperature range. Therefore, the R-T-B based permanent magnet according to the present embodiment can be stably produced.

The thus obtained R-T-B based permanent magnet according to the present embodiment is suitably employed in the following applications: for example, a surface permanent magnet (SPM) rotating machine having a magnet attached to the surface of a rotor, an interior permanent magnet (IPM) rotating machine such as an inner rotor brushless motor, and a permanent magnet reluctance motor (PRM). Specifically, the R-T-B based permanent magnet according to the present embodiment is suitably employed in applications such as a spindle motor for a hard disk rotating drive in a hard disk drive, a voice coil motor in a hard disk drive, a motor for an electric vehicle or a hybrid car, a motor for electric power steering in an automobile, a servo motor for a machine tool, a motor for a vibrator of a mobile phone, a motor for a printer, and a motor for generator.

The present disclosure is not limited to the above-described embodiments and may be modified in various ways within the scope of the present disclosure.

### EXAMPLES

Hereinafter, the present disclosure will be described in more detail with reference to Examples. However, the present disclosure is not limited to these Examples.

### Experiment 1

### (Manufacturing of Alloy for R-T-B Based Permanent Magnet)

Nd metal (purity: 99 mass % or more), an alloy of Nd and Pr (didymium, purity: 99 mass % or more), ferroboron (Fe content: 80 mass %, B content: 20 mass %), Fe metal (purity: 99 mass % or more), Co metal (purity: 99 mass % or more), Zr metal (purity: 99 mass % or more), Cu metal (purity: 99 mass %), Al metal (purity: 99 mass % or more), and/or Ga metal (purity: 99 mass % or more) were weighed according to the alloy compositions shown in Table 1 below and mixed to prepare raw material mixtures. The term “TRE” in Table 1 represents the total content (mass %) of the rare earth elements (Nd and Pr). The C content in each alloy for an R-T-B based permanent magnet was 0 mass % or more and 0.03 mass % or less. The term “bal.” represents the balance. The Fe content is indicated as “bal.” to show that the Fe content corresponds to the balance when the total amount of the alloy for an R-T-B based permanent magnet, containing elements other than those described in Table 1, is defined as 100 mass %.

The obtained raw material mixture was loaded into an alumina crucible, which is a refractory crucible. After the alumina crucible that was loaded with the raw material mixture was placed in a high-frequency vacuum induction furnace, the atmosphere inside the furnace was replaced with Ar. Then, the high-frequency vacuum induction furnace was heated to melt the raw material mixture that was loaded in the alumina crucible, thereby obtaining a molten alloy. The obtained molten alloy was cast by strip casting to form a cast alloy strip (the alloy for an R-T-B based permanent magnet). The casting was performed in an Ar atmosphere. The cast alloy strip was then crushed by a crusher that is disposed between the cooling roll and the collection container to obtain flake-like cast alloy pieces. The flake-like cast alloy pieces were allowed to accumulate in the collection container to form an accumulation.

The temperature of the molten alloy (casting temperature) was set at a temperature of 1300 to 1550° C. A copper alloy was used as the material of the cooling roll. The roll peripheral speed of the cooling roll was set to 1 m/s. The supply rate of the molten metal to the cooling roll (supply rate per unit contact width between the molten metal and the cooling roll) was set to 1.2 kg/(min cm).

An average cooling rate in the collection container was controlled by appropriately arranging a cooling member in the collection container. The temperature of the accumulation was measured using a sheath-type thermocouple whose tip was placed in advance near the expected center of the accumulation. Then, the average cooling rate of the accumulation was calculated from temperature changes in the accumulation. By cooling the accumulation, an alloy for an R-T-B based permanent magnet was obtained.

In Experiment 1, the average cooling rate of the accumulation in the collection container in the range from 600 to 400° C. was set to 1.8° C./s. The maximum temperature of the accumulation in all the Examples and Comparative Examples was 400° C. or more and 600° C. or less in Experiment 1. When the maximum temperature was 400° C. or more and 600° C. or less, the average cooling rate from the maximum temperature to 400° C. was regarded as the average cooling rate in the range from 600 to 400° C.

### (Measurement of Area Ratio of Each Phase)

The area ratio of each phase in the alloy for an R-T-B based permanent magnet was measured using an electron microscope.

First, evaluation samples were prepared. Specifically, during the step of supplying a manufacturing lot of the alloy for an R-T-B based permanent magnet by the above-described strip casting, flakes of the alloy, supplied at predetermined time intervals, were sampled (which may hereinafter be referred to simply as “alloy pieces”). More specifically, 30 alloy pieces were randomly collected, and each alloy piece was used as an evaluation sample.

Next, the thicknesses of the collected evaluation samples were measured. Among the 30 evaluation samples, the 2nd, 3rd, and 4th thickest samples were selected as thick samples, the 14th, 15th, and 16th thickest samples were selected as near-average samples, and the 27th, 28th, and 29th thickest samples were selected as thin samples.

Then, the nine selected evaluation samples were fixed using an instant adhesive and were processed to enable observation of cross sections parallel to the thickness direction. In fixing the evaluation samples, they were arranged so that it could be identified which evaluation sample was a thick sample, a near-average sample, or a thin sample.

The nine evaluation samples that were fixed with the instant adhesive were then embedded together in resin to obtain a single resin-embedded sample. In this state, the cross sections parallel to the thickness direction were mirror-polished to obtain an observation surface.

Next, the imaging mode was set to backscattered electron imaging mode, and the observation range was set at a magnification of 2500 and a resolution of 1280×960 pixels. Scanning was then performed from the roll surface to the free surface so as to observe the entire region between the roll surface to the free surface. Specifically, images were captured continuously from the roll surface to the free surface. Imaging was performed so that 7 to 10 images were obtained in each observation range. In this case, nine observation ranges were set and were observed. One observation range was set for each evaluation sample. On the observation surface of each evaluation sample, a portion exhibiting an average state was selected as the observation range.

Then, the area ratio of each phase in the observation range was calculated by analysis. The area ratios of the respective phases in the cross sections of the evaluation samples were then averaged, thereby obtaining the area ratio of each phase in the cross section of the alloy for an R-T-B based permanent magnet in the manufacturing lot. The results are shown in each table.

The presence or absence and area ratio of the 2-17 phase were determined from the backscattered electron image. The absence of the dot-like phase prior to hydrogen absorption (to be described later) was confirmed from the backscattered electron images in all Examples.

### (Measurement of Average Distance Between R-Rich Phases)

The luminance of the backscattered electron image was adjusted in the above-described observation range. Then, measurement lines perpendicular to the thickness direction of the alloy piece were set at intervals of 10 μm. Each measurement line was set to a length of 189 μm. Subsequently, the sum of the distances between R-rich phases along the measurement lines was divided by the number of measurement lines to calculate the average distance between R-rich phases.

### (Manufacture of R-T-B Based Permanent Magnet)

The alloy for an R-T-B based permanent magnet was allowed to absorb hydrogen at room temperature. Then, the alloy was subjected to a hydrogenation pulverization treatment (coarse pulverization) in which dehydrogenation was performed at 600° C. for 2 hours in an Ar atmosphere, whereby an alloy powder (coarsely pulverized powder) was obtained. In the present Examples, each step from the hydrogenation pulverization treatment to sintering (fine pulverization and pressing) was performed in a low-oxygen atmosphere having an oxygen concentration of less than 50 ppm.

Next, zinc stearate and stearamide were added to the alloy powder as pulverization aids, and they were mixed using a Nauta mixer. The amount of zinc stearate added was 0.05 parts by mass with respect to 100 parts by mass of the coarsely pulverized powder. The amount of stearamide added was 0.05 parts by mass with respect to 100 parts by mass of the coarsely pulverized powder. Then, fine pulverization was performed using a jet mill, and a finely pulverized powder having an average particle size of about 3.2 μm was obtained.

The obtained finely pulverized powder was charged into a mold, which was disposed between electromagnets. Pressing was performed on the powder at a pressure of 120 MPa while a magnetic field of 1200 kA/m was applied, whereby a green compact was obtained.

The obtained green compact was then sintered by holding it at 1050° C. for 4 hours in a vacuum, followed by quenching, thereby obtaining a sintered body having the magnet composition shown in Table 1. The obtained sintered body was subjected to a two-step aging treatment, in which it was held at 900° C. for 1 hour and then at 500° C. for 1 hour (both in an Ar atmosphere), whereby an R-T-B based permanent magnet (R-T-B based sintered magnet) was obtained.

### [Magnetic Properties]

Br, HcJ, and Hk/HcJ of the R-T-B based permanent magnet were measured at room temperature using a B-H tracer. The presence or absence of cracks in the R-T-B based permanent magnet was visually observed. The results are shown in Table 1.

Comprehensive evaluation was made as follows. Specifically, a sample satisfying the conditions that Hk/HcJ was 90% or more, HcJ was 1600 kA/m or more, Br was 1225 mT or more, and no cracks were observed, was evaluated as grade A. A sample satisfying the conditions that Hk/HcJ was 85% or more, HcJ was 1200 kA/m or more, Br was 1100 mT or more, and was not rated as grade A, was evaluated as grade B. A sample that was rated as neither grade A nor grade B, was evaluated as grade C. Grade A and grade B were defined as good, and more particularly, grade A was defined as excellent.

### [Table 1]

TABLE 1

| | Eample/ | | | | | | | | | | | |
|---|---|---|---|---|---|---|---|---|---|---|---|---|
| Sample | Comparative | Alloy Composition (mass %) | | | | | | | | | | |
| No. | Example | TRE | Nd | Pr | Fe | B | Al | Cu | Co | Zr | Ga | C |
| 2 | Comparative | 30.0 | 23.5 | 6.5 | bal. | 0.75 | 0.2 | 0.1 | 0.9 | 0.5 | 0.3 | 0.0 |
| | Example | | | | | | | | | | | |
| 1 | Example | 30.0 | 23.5 | 6.5 | bal. | 0.88 | 0.2 | 0.1 | 0.9 | 0.5 | 0.3 | 0.0 |
| 3 | Example | 30.0 | 23.5 | 6.5 | bal. | 1.00 | 0.2 | 0.1 | 0.9 | 0.5 | 0.3 | 0.0 |
| 4 | Example | 30.0 | 23.5 | 6.5 | bal. | 0.88 | 0.2 | 0.1 | 0.9 | 0.5 | 0.1 | 0.0 |
| 1 | Example | 30.0 | 23.5 | 6.5 | bal. | 0.88 | 0.2 | 0.1 | 0.9 | 0.5 | 0.3 | 0.0 |
| 5 | Example | 30.0 | 23.5 | 6.5 | bal. | 0.88 | 0.2 | 0.1 | 0.9 | 0.5 | 1.0 | 0.0 |
| 6 | Example | 30.0 | 23.5 | 6.5 | bal. | 0.88 | 0.2 | 0.1 | 0.9 | 0.5 | 1.5 | 0.0 |
| 7 | Example | 30.0 | 23.5 | 6.5 | bal. | 0.88 | 0.2 | 0.0 | 0.9 | 0.5 | 0.3 | 0.0 |
| 1 | Example | 30.0 | 23.5 | 6.5 | bal. | 0.88 | 0.2 | 0.1 | 0.9 | 0.5 | 0.3 | 0.0 |
| 8 | Example | 30.0 | 23.5 | 6.5 | bal. | 0.88 | 0.2 | 0.3 | 0.9 | 0.5 | 0.3 | 0.0 |
| 9 | Example | 30.0 | 23.5 | 6.5 | bal. | 0.88 | 0.2 | 0.5 | 0.9 | 0.5 | 0.3 | 0.0 |
| 10 | Example | 30.0 | 23.5 | 6.5 | bal. | 0.88 | 0.2 | 0.1 | 0.9 | 0.0 | 0.3 | 0.0 |
| 11 | Example | 30.0 | 23.5 | 6.5 | bal. | 0.88 | 0.2 | 0.1 | 0.9 | 0.3 | 0.3 | 0.0 |
| 1 | Example | 30.0 | 23.5 | 6.5 | bal. | 0.88 | 0.2 | 0.1 | 0.9 | 0.5 | 0.3 | 0.0 |
| 12 | Comparative | 30.0 | 23.5 | 6.5 | bal. | 0.88 | 0.2 | 0.1 | 0.9 | 1.0 | 0.3 | 0.0 |
| | Example | | | | | | | | | | | |
| 13 | Example | 30.0 | 23.5 | 6.5 | bal. | 0.88 | 0.1 | 0.1 | 0.9 | 0.5 | 0.3 | 0.0 |
| 1 | Example | 30.0 | 23.5 | 6.5 | bal. | 0.88 | 0.2 | 0.1 | 0.9 | 0.5 | 0.3 | 0.0 |
| 14 | Example | 30.0 | 23.5 | 6.5 | bal. | 0.88 | 0.4 | 0.1 | 0.9 | 0.5 | 0.3 | 0.0 |
| 15 | Example | 30.0 | 23.5 | 6.5 | bal. | 0.88 | 0.5 | 0.1 | 0.9 | 0.5 | 0.3 | 0.0 |
| 16 | Example | 30.0 | 23.5 | 6.5 | bal. | 0.88 | 0.2 | 0.1 | 0.4 | 0.5 | 0.3 | 0.0 |
| 1 | Example | 30.0 | 23.5 | 6.5 | bal. | 0.88 | 0.2 | 0.1 | 0.9 | 0.5 | 0.3 | 0.0 |
| 17 | Example | 30.0 | 23.5 | 6.5 | bal. | 0.88 | 0.2 | 0.1 | 2.0 | 0.5 | 0.3 | 0.0 |
| 18 | Example | 30.0 | 23.5 | 6.5 | bal. | 0.88 | 0.2 | 0.1 | 3.0 | 0.5 | 0.3 | 0.0 |

Microstructure

| | |
|---|---|
| Distance | Magnet Characteristics |

| | Inter- | | between | | | | | Compre- |
|---|---|---|---|---|---|---|---|---|
| | mediate | 2-17 | R-rich | | | | | hensive |
| Sample | Phase | Phase | Phases | Hk/HcJ | HcJ | Br | | Evalu- |
| No. | (%) | (%) | (μm) | (%) | (kA/m) | (mT) | Cracks | ation |
| 2 | 19.0 | 4.3 | 2.0 | 75 | 2407 | 1074 | None | C |
| 1 | 5.6 | None | 2.5 | 95 | 1826 | 1253 | None | A |
| 3 | 0.7 | None | 2.5 | 96 | 1329 | 1405 | None | B |
| 4 | 4.6 | None | 2.5 | 94 | 1803 | 1259 | None | A |
| 1 | 5.6 | None | 2.5 | 95 | 1826 | 1253 | None | A |
| 5 | 4.6 | None | 2.5 | 98 | 1855 | 1229 | None | A |
| 6 | 2.9 | None | 2.5 | 95 | 1787 | 1167 | None | B |
| 7 | 4.8 | None | 2.5 | 94 | 1786 | 1224 | None | B |
| 1 | 5.6 | None | 2.5 | 95 | 1826 | 1253 | None | A |
| 8 | 5.0 | None | 2.5 | 95 | 1804 | 1256 | None | A |
| 9 | 4.6 | None | 2.5 | 93 | 1589 | 1249 | None | B |
| 10 | 0.6 | None | 2.5 | 96 | 1302 | 1413 | None | B |
| 11 | 2.8 | None | 2.5 | 99 | 1616 | 1317 | None | A |
| 1 | 5.6 | None | 2.5 | 95 | 1826 | 1253 | None | A |
| 12 | 17.3 | 4.2 | 2.0 | 80 | 2353 | 1092 | None | C |
| 13 | 5.4 | None | 2.5 | 94 | 1820 | 1258 | None | A |
| 1 | 5.6 | None | 2.5 | 95 | 1826 | 1253 | None | A |
| 14 | 6.4 | None | 2.5 | 98 | 1857 | 1226 | None | A |
| 15 | 6.2 | None | 2.5 | 95 | 1848 | 1215 | None | B |
| 16 | 6.0 | None | 2.5 | 97 | 1843 | 1249 | None | A |
| 1 | 5.6 | None | 2.5 | 95 | 1826 | 1253 | None | A |
| 17 | 3.9 | None | 2.5 | 90 | 1761 | 1260 | None | A |
| 18 | 2.4 | None | 2.5 | 85 | 1701 | 1268 | None | B |

As shown in Table 1, the R-T-B based permanent magnets that were manufactured using alloys for R-T-B based permanent magnets having an area ratio of the 6-13-1 phase of 7.0% or less, exhibited good properties. On the other hand, Sample No. 2 having a small B content and Sample No. 12 having a large Zr content had an excessively large area ratio of the 6-13-1 phase. Thus, the R-T-B based permanent magnets that were manufactured using the alloys for the R-T-B based permanent magnets having an excessively large area ratio of the 6-13-1 phase, exhibited inferior properties.

### Experiment 2

Sample Nos. 19 to 22 were manufactured under the same conditions as in Sample No. 1 of Experiment 1, except that the average cooling rate was varied.

In Sample No. 19, the temperature was controlled so that the maximum temperature of the accumulation exceeded 600° C. and the average cooling rates in the range from 800 to 600° C. and from 600 to 400° C. would be 0.3° C./s and 0.2° C./s, respectively. When the maximum temperature exceeded 600° C. but was not more than 800° C., the average cooling rate in the range from the maximum temperature to 600° C. was regarded as the average cooling rate in the range from 800 to 600° C.

In Sample Nos. 20 to 22, the temperatures were controlled so that the average cooling rates of the accumulations in the range from 600 to 400° C. would be the values shown in Table 2. The maximum temperatures of the accumulations for Sample Nos. 20 to 22 were 400° C. or more and 600° C. or less.

Sample Nos. 23 and 24 were manufactured under the same conditions as in Sample No. 1 of Experiment 1, except that the accumulations in the collection container were held at predetermined temperatures. Specifically, the accumulations were held at the temperatures and for the times shown in Table 2. Thereafter, the accumulations were cooled to room temperature. The cooling was controlled so that the average cooling rate in the range from the holding temperature to 400° C. would be 2.5° C./s.

In Sample No. 25, the alloy for an R-T-B based permanent magnet was prepared under the same conditions as in the alloy for Sample No. 1. Then, an R-T-B based permanent magnet was manufactured under the same conditions as in Sample No. 1, except that the dehydrogenation temperature was 500° C.

TABLE 2

| | | Average Cooling | | | | |
|---|---|---|---|---|---|---|
| | | Rate | | | | |
| | | (° C./s) | | | | |
| | Example/ | 800 | 600 | Hoding | Holding | Dehydrogenation |
| Sample | Comparative | to | to | Time | Temperature | Temperature |
| No. | Example | 600° C. | 400° C. | (hr) | (° C.) | (° C.) |
| 19 | Comparative | 0.3 | 0.2 | Not held | | 600 |
| | Example | | | | | |
| 20 | Example | — | 1.7 | Not held | | 600 |
| 1 | Example | — | 1.8 | Not held | | 600 |
| 21 | Example | — | 2.2 | Not held | | 600 |
| 22 | Example | — | 10.0 | Not held | | 600 |
| 23 | Comparative | Held | | 1 | 580 | 600 |
| | Example | | | | | |

| | | | | | |
|---|---|---|---|---|---|
| 24 | Example | Held | 1 | 800 | 600 |

| | | | | | |
|---|---|---|---|---|---|
| 25 | Example | — | 1.8 | Not held | 500 |

Microstructure

| | |
|---|---|
| Distance | Magnet Characteristics |

| | Inter- | | between | | | | | Compre- |
|---|---|---|---|---|---|---|---|---|
| | mediate | 2-17 | R-rich | | | | | hensive |
| Sample | Phase | Phase | Phases | Hk/HcJ | HcJ | Br | | Evalu- |
| No. | (%) | (%) | (μm) | (%) | (kA/m) | (mT) | Cracks | ation |
| 19 | 7.9 | None | 3.1 | 79 | 1802 | 1252 | None | C |
| 20 | 3.7 | None | 2.6 | 99 | 1799 | 1249 | None | A |
| 1 | 5.6 | None | 2.5 | 95 | 1826 | 1253 | None | A |
| 21 | 5.9 | None | 2.2 | 94 | 1811 | 1247 | None | A |
| 22 | 0.5 | None | 1.5 | 95 | 1820 | 1220 | None | B |
| 23 | 9.2 | None | 2.3 | 41 | 1810 | 1253 | None | C |
| 24 | 2.8 | 1.4 | 5.8 | 89 | 1590 | 1253 | None | B |
| 25 | 5.6 | None | 2.5 | 99 | 1822 | 1250 | Present | B |

As shown in Table 2, the R-T-B based permanent magnets that were manufactured using alloys for R-T-B based permanent magnets having an area ratio of the 6-13-1 phase of 7.0% or less, exhibited good properties. On the other hand, the area of the 6-13-1 phase was excessively large in Sample No. 19, in which the average cooling rate was small, and in Sample No. 23, in which the accumulation was held at the holding temperature of 580° C. for 1 hour. Thus, the R-T-B based permanent magnets that were manufactured using the alloy for the R-T-B based permanent magnet having an excessively large area of the 6-13-1 phase, exhibited inferior properties.

### Experiment 3

Samples were manufactured under the same conditions as in Experiment 1, except that the composition of the alloy for an R-T-B based permanent magnet was varied. Results are shown in Table 3.

TABLE 3

| | Eample/ | | | | | | | | | | | |
|---|---|---|---|---|---|---|---|---|---|---|---|---|
| Sample | Comparative | Alloy Composition (mass %) | | | | | | | | | | |
| No. | Example | TRE | Nd | Pr | Fe | B | Al | Cu | Co | Zr | Ga | C |
| 32 | Comparative | 31.5 | 25.3 | 6.2 | bal. | 0.75 | 0.3 | 0.2 | 0.9 | 0.5 | 0.6 | 0.0 |
| | Example | | | | | | | | | | | |
| 33 | Example | 31.5 | 25.3 | 6.2 | bal. | 0.85 | 0.3 | 0.2 | 0.9 | 0.5 | 0.6 | 0.0 |
| 31 | Example | 31.5 | 25.3 | 6.2 | bal. | 0.86 | 0.3 | 0.2 | 0.9 | 0.5 | 0.6 | 0.0 |
| 34 | Example | 31.5 | 25.3 | 6.2 | bal. | 0.90 | 0.3 | 0.2 | 0.9 | 0.5 | 0.6 | 0.0 |
| 35 | Example | 31.5 | 25.3 | 6.2 | bal. | 1.00 | 0.3 | 0.2 | 0.9 | 0.5 | 0.6 | 0.0 |
| 36 | Example | 31.5 | 25.3 | 6.2 | bal. | 0.86 | 0.3 | 0.2 | 0.9 | 0.5 | 0.1 | 0.0 |
| 31 | Example | 31.5 | 25.3 | 6.2 | bal. | 0.86 | 0.3 | 0.2 | 0.9 | 0.5 | 0.6 | 0.0 |
| 37 | Example | 31.5 | 25.3 | 6.2 | bal. | 0.86 | 0.3 | 0.2 | 0.9 | 0.5 | 1.0 | 0.0 |
| 38 | Example | 31.5 | 25.3 | 6.2 | bal. | 0.86 | 0.3 | 0.2 | 0.9 | 0.5 | 1.5 | 0.0 |
| 39 | Example | 31.5 | 25.3 | 6.2 | bal. | 0.86 | 0.3 | 0.2 | 0.9 | 0.1 | 0.6 | 0.0 |
| 31 | Example | 31.5 | 25.3 | 6.2 | bal. | 0.86 | 0.3 | 0.2 | 0.9 | 0.5 | 0.6 | 0.0 |
| 40 | Comparative | 31.5 | 25.3 | 6.2 | bal. | 0.86 | 0.3 | 0.2 | 0.9 | 1.0 | 0.6 | 0.0 |
| | Example | | | | | | | | | | | |

Microstructure

| | |
|---|---|
| Distance | Magnet Characteristics |

| | Inter- | | between | | | | | Compre- |
|---|---|---|---|---|---|---|---|---|
| | mediate | 2-17 | R-rich | | | | | hensive |
| Sample | Phase | Phase | Phases | Hk/HcJ | HcJ | Br | | Evalu- |
| No. | (%) | (%) | (μm) | (%) | (kA/m) | (mT) | Cracks | ation |
| 32 | 16.9 | 5.7 | 2.0 | 67 | 2337 | 1310 | None | C |
| 33 | 6.8 | None | 2.5 | 87 | 1898 | 1348 | None | B |
| 31 | 6.0 | None | 2.5 | 94 | 1855 | 1352 | None | A |
| 34 | 3.6 | None | 2.5 | 96 | 1780 | 1370 | None | A |
| 35 | 0.4 | None | 2.5 | 95 | 1248 | 1404 | None | B |
| 36 | 3.1 | None | 2.5 | 91 | 1798 | 1369 | None | A |
| 31 | 6.0 | None | 2.5 | 94 | 1855 | 1352 | None | A |
| 37 | 4.4 | None | 2.5 | 96 | 1850 | 1338 | None | A |
| 38 | 2.7 | None | 2.5 | 96 | 1783 | 1276 | None | B |
| 39 | 1.2 | None | 2.5 | 97 | 1430 | 1388 | None | B |
| 31 | 6.0 | None | 2.5 | 94 | 1855 | 1352 | None | A |
| 40 | 18.4 | 5.5 | 2.0 | 80 | 2387 | 1306 | None | C |

As shown in Table 3, the R-T-B based permanent magnets that were manufactured using alloys for R-T-B based permanent magnets having an area ratio of the 6-13-1 phase of 7.0% or less, exhibited good properties. On the other hand, the area of the 6-13-1 phase was excessively large in Sample No. 32 having a small B content and in Sample No. 40 having a large Zr content. Thus, the R-T-B based permanent magnets that were manufactured using the alloy for the R-T-B based permanent magnet having an excessively large area of the 6-13-1 phase, exhibited inferior properties.

### Experiment 4

Sample Nos. 41 and 42 were manufactured under the same conditions as in Sample No. 31 of Experiment 3, except that the average cooling rate was varied.

In Sample No. 41, the temperature was controlled so that the maximum temperature of the accumulation exceeded 600° C. and the average cooling rates in the range from 800 to 600° C. and from 600 to 400° C. would be 0.3° C./s and 0.2° C./s, respectively. When the maximum temperature exceeded 600° C. but was not more than 800° C., the average cooling rate in the range from the maximum temperature to 600° C. was regarded as the average cooling rate in the range from 800 to 600° C.

For Sample No. 42, the temperature was controlled so that the average cooling rate of the accumulation in the range from 600 to 400° C. would be 10.0° C./s. The maximum temperature of the accumulation for Sample No. 42 was 400° C. or more and 600° C. or less.

Sample Nos. 43 and 44 were manufactured under the same conditions as in Sample No. 31 of Experiment 3, except that the accumulations were held in the collection container at predetermined temperatures. Specifically, the accumulations were held at the temperatures and for the times shown in Table 4. Thereafter, the accumulations were cooled to room temperature. The cooling was controlled so that the average cooling rate in the range from the holding temperature to 400° C. would be 2.5° C./s.

For Sample No. 45, the alloy for an R-T-B based permanent magnet was prepared under the same conditions as in the alloy for Sample No. 31. Then, an R-T-B based permanent magnet was manufactured under the same conditions as in Sample No. 31, except that the dehydrogenation temperature was 500° C.

TABLE 4

| | | Average Cooling | | | | |
|---|---|---|---|---|---|---|
| | | Rate | | | | |
| | | (° C./s) | | | | |
| | Eample/ | 800 | 600 | Hoding | Holding | Dehydrogenation |
| Sample | Comparative | to | to | Time | Temperature | Temperature |
| No. | Example | 600° C. | 400° C. | (hr) | (° C.) | (° C.) |

| | | | | | |
|---|---|---|---|---|---|
| 41 | Comparative | 0.3 | 0.2 | Not held | 600 |
| | Example | | | | |
| 31 | Example | — | 1.8 | Not held | 600 |
| 42 | Example | — | 10.0 | Not held | 600 |

| | | | | | |
|---|---|---|---|---|---|
| 43 | Comparative | Held | 1 | 580 | 600 |
| | Example | | | | |
| 44 | Example | Held | 1 | 800 | 600 |

| | | | | | |
|---|---|---|---|---|---|
| 45 | Example | — | 1.8 | Not held | 500 |

Microstructure

| | |
|---|---|
| Distance | Magnet Characteristics |

| | Inter- | | between | | | | | Compre- |
|---|---|---|---|---|---|---|---|---|
| | mediate | 2-17 | R-rich | | | | | hensive |
| Sample | Phase | Phase | Phases | Hk/HcJ | HcJ | Br | | Evalu- |
| No. | (%) | (%) | (μm) | (%) | (kA/m) | (mT) | Cracks | ation |
| 41 | 7.5 | None | 3.1 | 78 | 1831 | 1351 | None | C |
| 31 | 6.0 | None | 2.5 | 94 | 1855 | 1352 | None | A |
| 42 | 0.5 | None | 1.5 | 94 | 1850 | 1322 | None | B |
| 43 | 9.9 | None | 2.3 | 40 | 1838 | 1352 | None | C |
| 44 | 3.0 | 2.0 | 5.8 | 87 | 1655 | 1352 | None | B |
| 45 | 6.0 | None | 2.5 | 97 | 1850 | 1349 | Present | B |

As shown in Table 4, the R-T-B based permanent magnets that were manufactured using alloys for R-T-B based permanent magnets having an area ratio of the 6-13-1 phase of 7.0% or less, exhibited good properties. On the other hand, the area ratio of the 6-13-1 phase was excessively large in Sample No. 41, in which the average cooling rate was small, and in Sample No. 43, in which the accumulation was held at the holding temperature of 580° C. for 1 hour. Thus, the R-T-B based permanent magnets that were manufactured using the alloy for the R-T-B based permanent magnet having an excessively large area ratio of the 6-13-1 phase, exhibited inferior properties.

### Experiment 5

Sample No. 32a was manufactured under the same conditions as in Sample No. 32 of Experiment 3, except that the sintering temperature was set to 1000° C. and the sintering time was set to 48 hours. Sample No. 46 was manufactured under the same conditions as in Sample No. 32 of Experiment 3, except that the B content was varied, the sintering temperature was set to 1000° C., and the sintering time was set to 48 hours. Sample No. 46a was manufactured under the same conditions as in Sample No. 32 of Experiment 3, except that the B content was varied. Results are shown in Table 5.

TABLE 5

| | | | | | | | | | | | | | Microstructure |
|---|---|---|---|---|---|---|---|---|---|---|---|---|---|
| | Eample/ | | | | | | | | | | | | Intermediate |
| Sample | Comparative | Alloy Composition (mass %) | | | | | | | | | | | Phase |
| No. | Example | TRE | Nd | Pr | Fe | B | Al | Cu | Co | Zr | Ga | C | (%) |
| 32 | Comparative | 31.5 | 25.3 | 6.2 | bal | 0.75 | 0.3 | 0.2 | 0.9 | 0.5 | 0.6 | 0.0 | 16.9 |
| | Example | | | | | | | | | | | | |
| 32a | Comparative | 31.5 | 25.3 | 6.2 | bal | 0.75 | 0.3 | 0.2 | 0.9 | 0.5 | 0.6 | 0.0 | 16.9 |
| | Example | | | | | | | | | | | | |
| 46 | Example | 31.5 | 25.3 | 6.2 | bal | 0.78 | 0.3 | 0.2 | 0.9 | 0.5 | 0.6 | 0.0 | 5.1 |
| 46a | Reference | 31.5 | 25.3 | 6.2 | bal | 0.78 | 0.3 | 0.2 | 0.9 | 0.5 | 0.6 | 0.0 | 5.1 |
| | Example | | | | | | | | | | | | |

| | Microstructure | | | | | | | | |
|---|---|---|---|---|---|---|---|---|---|
| | | Distance | Sintering Conditions | | Magnet Characteristics | | | | |
| | | between | | Sinter- | | | | | Compre- |
| | 2-17 | R-rich | Sintering | ing | Hk/ | | | | hensive |
| Sample | Phase | Phases | Temperature | Time | HcJ | HcJ | Br | | Evalu- |
| No. | (%) | (μm) | (° C.) | (h) | (%) | (kA/m) | (mT) | Cracks | ation |
| 32 | 5.7 | 2.0 | 1050 | 4 | 67 | 2337 | 1310 | None | C |
| 32a | 5.7 | 2.0 | 1000 | 48 | 80 | 2360 | 1310 | None | C |
| 46 | None | 2.5 | 1000 | 48 | 95 | 2230 | 1320 | None | A |
| 46a | None | 2.5 | 1050 | 4 | 83 | 2220 | 1325 | None | C |

As shown in Table 5, even when the B content was lower than the B contents of the Examples shown in Tables 1 to 4, alloys for R-T-B based permanent magnets having an area ratio of the 6-13-1 phase of 7.0% or less were obtained. Moreover, an R-T-B based permanent magnet that was manufactured using this alloy by sintering at a relatively low temperature for a relatively long time, exhibited good properties.

On the other hand, in using an alloy for an R-T-B based permanent magnet having an excessively large area ratio of the 6-13-1 phase due to the low B content, an R-T-B based permanent magnet having good properties was not obtained even though sintering was performed at a relatively low temperature for a relatively long time.

### Experiment 6

Sample Nos. 47 and 48 were manufactured by the dual alloy method. The composition and microstructure of the main-phase alloys are shown in Table 6. The composition of the boundary-phase alloy is shown in Table 7. In the boundary-phase alloy, the area ratio of the 6-13-1 phase was 4.0%, and the a-Fe phase was not observed.

The manufacturing conditions of the main-phase alloy Nos. 1 and 2 were set so that the maximum temperatures of the accumulations exceeded 400° C. Moreover, cooling was controlled so that the average cooling rate in the range from 600 to 400° C. would be 2.2° C./s. The accumulations were not held at predetermined temperatures in the collection container.

The manufacturing conditions of the boundary-phase alloy No. 1 were set so that the maximum temperature of the accumulation exceeded 600° C. Moreover, cooling was controlled so that the average cooling rates in the range from 800 to 600° C. and from 600 to 400° C. would be 3.5° C./s and 3.0° C./s, respectively. The accumulation was not held at a predetermined temperature in the collection container.

In Sample No. 47, the main-phase alloy No. 1 and the boundary-phase alloy No. 1 were mixed in a ratio of 93:7. In Sample No. 48, the main-phase alloy No. 2 and the boundary-phase alloy No. 1 were mixed in a ratio of 90:10. Except for the above, the magnets were manufactured under the same conditions as in Sample No. 32 of Experiment 3. The compositions and properties of the obtained magnets are shown in Table 8.

TABLE 6

| | | | | | | | | | | | | | Microstructure | | |
|---|---|---|---|---|---|---|---|---|---|---|---|---|---|---|---|
| | | | | | | | | | | | | | | | Distance |
| | | | | | | | | | | | | | | | between |
| | Example/ | | | | | | | | | | | | Intermediate | 2-17 | R-rich |
| Main-Phase | Comparative | Alloy Composition (mass %) | | | | | | | | | | | Phase | Phase | Phases |
| Alloy No. | Example | TRE | Nd | Pr | Fe | B | Al | Cu | Co | Zr | Ga | C | (%) | (%) | (μm) |
| 1 | Example | 31.5 | 25.3 | 6.2 | bal. | 0.75 | 0.3 | 0.2 | 0.5 | 0.5 | 0.6 | 0.2 | 1.5 | None | 2.5 |
| 2 | Example | 31.5 | 25.3 | 6.2 | bal. | 0.78 | 0.3 | 0.2 | 0.5 | 0.5 | 0.6 | 0.2 | 1.3 | None | 2.5 |
| 32 in Table 3 | Comparative | 31.5 | 25.3 | 6.2 | bal. | 0.75 | 0.3 | 0.2 | 0.9 | 0.5 | 0.6 | 0.0 | 16.9 | 5.7 | 2.0 |
| | Example | | | | | | | | | | | | | | |

TABLE 7

| Boundary- | | | | | | | | | | | |
|---|---|---|---|---|---|---|---|---|---|---|---|
| Phase | Alloy Composition (mass %) | | | | | | | | | | |
| Alloy No. | TRE | Nd | Pr | Fe | B | Al | Cu | Co | Zr | Ga | C |
| 1 | 31.5 | 25.3 | 6.2 | bal. | 0.0 | 0.3 | 0.2 | 5.0 | 5.0 | 0.0 | 0.0 |

TABLE 8

| | | Ratio of | Ratio of | | | | | | | | | |
|---|---|---|---|---|---|---|---|---|---|---|---|---|
| | Mixing Ratio | Main- | Boundary- | | | | | | | | | |
| Magnet | Main-Phase | Phase | Phase | Alloy Composition (mass %) | | | | | | | | |
| Sample No. | Alloy No. | Alloy | Alloy | TRE | Nd | Pr | Fe | B | Al | Cu | Co | Zr |
| 32 | 32 in Table 3 | 100 | 0 | 31.5 | 25.3 | 6.2 | bal. | 0.75 | 0.3 | 0.2 | 0.9 | 0.5 |
| 47 | 1 | 93 | 7 | 31.5 | 25.3 | 6.2 | bal. | 0.70 | 0.3 | 0.2 | 0.9 | 0.9 |
| 48 | 2 | 90 | 10 | 31.5 | 25.3 | 6.2 | bal. | 0.70 | 0.3 | 0.2 | 0.9 | 0.9 |

| | | | Magnet Characteristics | | | | |
|---|---|---|---|---|---|---|---|
| | | | | | | | Compre- |
| | | | | | | | hensive |
| Magnet | Alloy Composition (mass %) | | Hk/HcJ | HcJ | Br | | Evalu- |
| Sample No. | Ga | C | (%) | (kA/m) | (mT) | Cracks | ation |
| 32 | 0.6 | 0.1 | 67 | 2337 | 1310 | None | C |
| 47 | 0.6 | 0.3 | 95 | 2440 | 1301 | None | A |
| 48 | 0.6 | 0.3 | 95 | 2430 | 1302 | None | A |

As shown in Tables 6 to 8, even when the B content in the main-phase alloy was 0.75 mass % or 0.78 mass %, the area ratio of the 6-13-1 phase in the main-phase alloy tended to decrease by increasing the C content in the main-phase alloy to be greater than that in other Examples and Comparative Examples. Thus, main-phase alloys having an area ratio of the 6-13-1 phase of 7.0% or less were obtained. The R-T-B based permanent magnets that were manufactured by the dual alloy method using such main-phase alloys exhibited good properties.

All of the alloys shown in Tables 1 to 5 and all of the main-phase alloys shown in Table 6 were observed, and the backscattered electron images thereby obtained were subjected to ternarization using the k-means clustering. After ternarization was performed, a white phase having a luminance of 201 to 255, a main phase having a luminance of 0 to 119, and an intermediate phase having a luminance of 120 to 200 were observed in the backscattered electron images. Moreover, the intermediate phase was identified as the 6-13-1 phase. Specifically, in the intermediate phase, the value that was obtained by dividing the total ratio of Fe and Co by the total ratio of rare earth elements, in terms of number of atoms, was more than 1.0 and not more than 3.0.

### REFERENCE SIGNS LIST

11 . . . white phase (R-rich phase)
13 . . . 6-13-1 phase (R-rich phase)
15 . . . main phase
17 . . . dot-like phase
21 . . . measurement line
101 . . . . R-rich phase

What is claimed is:

1. An alloy for an R-T-B based permanent magnet, comprising at least one rare earth element, at least one selected from the group consisting of Fe and Co, boron, and M, wherein
M is at least one selected from the group consisting of Ga, Al, Cu, Zn, In, P, Sb, Si, Ge, Sn, and Bi,
the alloy comprises a main phase and an R-rich phase, and
an area ratio of a 6-13-1 phase, which is a type of the R-rich phase, is 7.0% or less in a cross section of the alloy.

2. The alloy for the R-T-B based permanent magnet according to claim 1, wherein the area ratio of the 6-13-1 phase is 1.0% or more and 6.5% or less.

3. The alloy for the R-T-B based permanent magnet according to claim 1, wherein an area ratio of a 2-17 phase is 2.0% or less in a cross section of the alloy.

4. The alloy for the R-T-B based permanent magnet according to claim 1, wherein the content of boron is 0.78 mass % or more and 0.95 mass % or less.

5. The alloy for the R-T-B based permanent magnet according to claim 1, wherein the content of boron is 0.80 mass % or more and 0.95 mass % or less.

6. The alloy for the R-T-B based permanent magnet according to claim 1, wherein the content of boron is 0.83 mass % or more and 0.90 mass % or less.

7. The alloy for the R-T-B based permanent magnet according to claim 1, wherein the content of boron is 0.75 mass % or more and 0.95 mass % or less, and the content of carbon is 0.05 mass % or more and 0.25 mass % or less.

8. The alloy for the R-T-B based permanent magnet according to claim 7, wherein the total of the content of boron and the content of carbon is 0.80 mass % or more and 1.20 mass % or less, and a value that is obtained by dividing the content of carbon by the content of boron is 0.05 or more and 0.33 or less.

9. The alloy for the R-T-B based permanent magnet according to claim 1, wherein the content of Ga is 0.10 mass % or more and 0.70 mass % or less.

10. The alloy for the R-T-B based permanent magnet according to claim 1, wherein the total content of rare earth elements is 30.0 mass % or more and 33.0 mass % or less.

11. The alloy for the R-T-B based permanent magnet according to claim 1, wherein the total content of rare earth elements is 30.0 mass % or more and 33.0 mass % or less, the content of Al is 0.1 mass % or more and 0.4 mass % or less, the content of Co is 0.4 mass % or more and 1.1 mass % or less, the content of Cu is 0.05 mass % or more and 0.2 mass % or less, the content of Zr is 0.15 mass % or more and 0.7 mass % or less, and the content of Ga is 0.10 mass % or more and 0.70 mass % or less.

12. A method for manufacturing an alloy for an R-T-B based permanent magnet, comprising:
solidifying a molten alloy to obtain a cast alloy strip;
crushing the cast alloy strip to obtain cast alloy pieces; and
cooling the cast alloy pieces, wherein,
a cooling rate in a range from 600 to 400° C. is 0.7° C./s or more in cooling the cast alloy pieces.

13. A method for manufacturing an R-T-B based permanent magnet, comprising hydrogenation pulverization on the alloy for the R-T-B based permanent magnet according to claim 1, wherein,
a dehydrogenation temperature is 530° C. or more and 650° C. or less in performing hydrogenation pulverization.
